(19) United States
(12) Patent Application Publication
(10) Pub. No.: US 2009/0064028 A1
(43) Pub. Date: Mar. 5, 2009

(54) DECISION TREE DEVICE AND WEBSITE FOR PROVIDING INFORMATION

(75) Inventors: Michael J. Garvey, Appleton, WI (US); Jason C. Cohen, Appleton, WI (US)

Correspondence Address: PATRICK W. RASCHE;ARMSTRONG TEASDALE LLP, ONE METROPOLITAN SQUARE, SUITE 2600, ST. LOUIS, MO, 63102-2740, US

(73) Assignee: Kimberly-Clark Worldwide, Inc., Neenah, WI (US)

(21) Appl. No.: 11/847,953

(22) Filed: Aug. 30, 2007

(51) Int. Cl. G06F 3/048

(52) U.S. Cl. 715/781

(57) ABSTRACT

Devices and downloads employing analysis software executed by a processor. Instructions display questions and receive user input to identify a topic. Instructions display questions and receive user input to define circumstances within the identified topic. Instructions present an output information relating to the identified topic as a function of the defined circumstances wherein the output information comprises at least one of a solution, a course of action or a definition of a problem.

### FIELD OF THE INVENTION

The present invention generally relates to assisting an individual in determining output information relating to a topic. In particular, the invention includes a device and/or website and/or software for assisting a consumer in finding a solution, a course of action and/or a definition of a problem.

### BACKGROUND OF THE INVENTION

U.S. published patent application 200610160594A describes a hand-held system that asks 20 questions based on the game “20 Questions.” In this application, a hand-held system provides a solution based on answers to 20 questions for which the end user had previously predetermined the answer. Website www.20Q.net is a web-based version of the hand-held system.

There is a need for a product which differs from the above noted hand-held system. For example, there is need for a product in which the user may not know the right answer or the right question to ask. Additionally, such products should optionally have means of editing decision tree algorithms depending on end user category needs (e.g., caregiving versus wine selection) via either a download or other data transfer systems (e.g., flash cards).

There is also a need for a system which recognizes using a series of questions to guide a solution of a need or a state. For example, www.springboardnetworks.com describes a shopping cart system to help aid in shopping. A device is attached to the shopping cart to provide guidance to shoppers by allowing price scanning and totaling. This system fails to recognize using a series of questions to guide a solution of a need or a state.

### SUMMARY OF THE INVENTION

The invention comprises analysis software stored in a storage and executed by a processor. The software includes instructions for displaying questions on a display and receiving user input to identify a topic; instructions for displaying questions on the display and receiving user input to define circumstances within the identified topic; and instructions for presenting on the display output information relating to the identified topic as a function of the defined circumstances. The output information comprises at least one of a solution, a course of action or a definition of a problem. The instructions may be executed by a processor or executed by a remote server accessible via the Internet.

Other objects and features will be in part apparent and in part pointed out hereinafter.

### BRIEF DESCRIPTION OF THE DRAWINGS

FIG. 1 is a block diagram of one embodiment of a device according to the invention.

FIG. 2 is a block diagram of one embodiment including a server for providing a website according to the invention.

FIG. 3 is a block diagram of one embodiment of a device according to the invention with flash memory and/or instructions for printing coupons.

FIG. 4 is a flow chart of one embodiment of instructions relating to product sizing according to the invention.

FIG. 5 is a flow chart of one embodiment of instructions relating to a crying decision according to the invention.

Corresponding reference characters indicate corresponding parts throughout the drawings.

### DESCRIPTION OF THE PREFERRED EMBODIMENTS

One aspect of the present invention is directed to today's information world. People have access to a multitude of different resources. However, information can be either cumbersome to come by (e.g., have to search the web for a simple answer) or located in large, difficult to travel systems (e.g., computer based or a single chapter in a large book, both difficult to carry). Generally, you have to know either a keyword or an entire question in order to be efficient in finding the information you need.

The exact area to search can be difficult since only a general topic is known, and only by a series of more questions can the exact information be discovered. In most cases this process is time consuming and unsatisfying. Depending on the situation, one may not have access to information (no computer for Internet access) and be forced to either read a book or call for information.

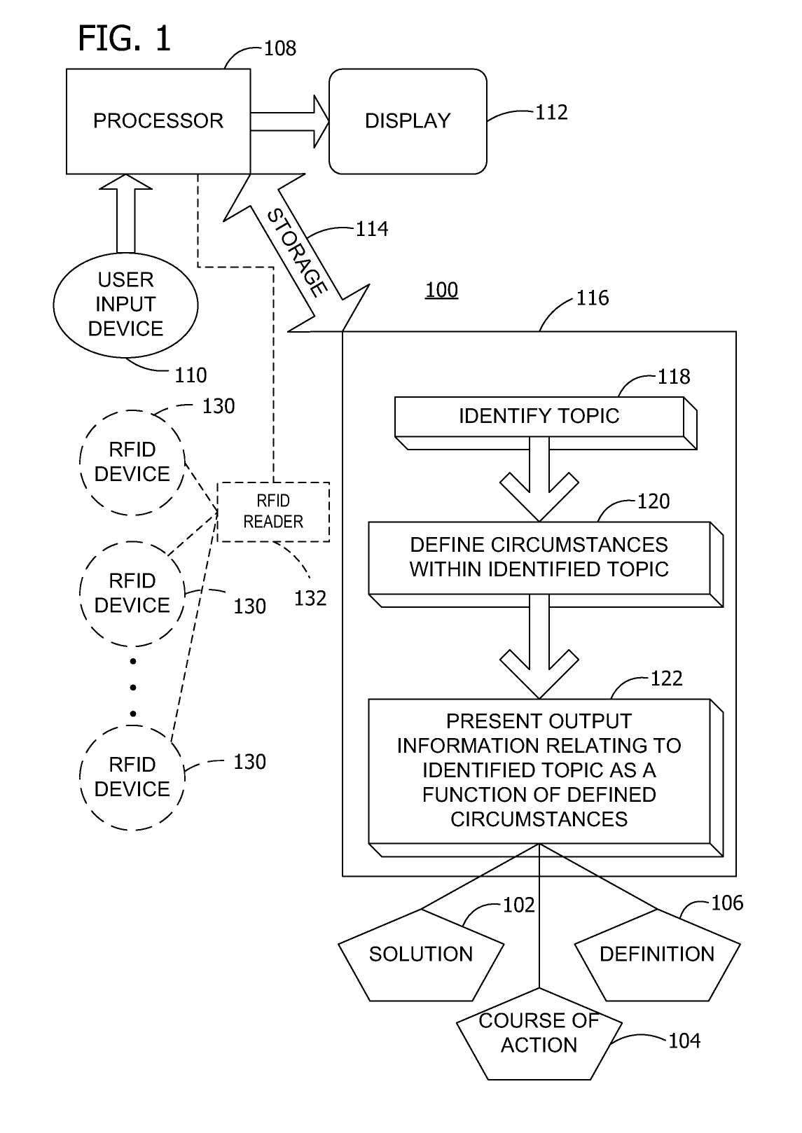

Disclosed in this application is a device designed to clearly display questions and suggest solutions based on specific input from the user. FIG. 1 is a block diagram of one embodiment of a device 100 according to the invention. For example, it is contemplated that the device 100 may be hand held device. The device would include analysis software 116 which in one embodiment would implement a decision tree guiding a user via a series of questions to either a solution 102 or a course of action 104 or information to better define a problem 106.

As illustrated in FIG. 1 in block form, a processor 108 connected to a user input device 110 is responsive to user input. The processor 108 is connected to a display 112 and drives the display 112 in response to the received user input via device 110. A storage 114, such a memory device, stores analysis software 116 executed by the processor 108. The analysis software 116 includes instructions 118 for identifying a topic. For example, the instructions 118 may display questions on the display 112 and receive user input via device 110 answering the questions to assist the user in identifying a topic.

The analysis software 116 also includes instructions 120 for defining circumstances with regard to the topic defined by the instructions 118. For example, the instructions 120 may display questions on the display 112 and receive user input via device 110 to define circumstances within the identified topic

The analysis software 116 also includes instructions 122 for presenting on the display 112 output information relating to the topic identified by instructions 118 as a function of the circumstances defined by instructions 120. For example, the output information may be a solution 102 to a problem or question, and/or a course of action 104 in response to an identified condition or request, and/or a definition 106 in response to an uncertainty or question. For example, the topic may be a fever, the circumstances may be symptoms accompanying the fever and the output information may be a period of time that the fever is expected to last (solution), a suggestion for treating the fever (course of action) or an indication of the root cause of the fever (definition).

Those skilled in the art will recognize many types of topics, circumstances and output information. The following examples are exemplary and not intended to be limiting. For example, the topic may comprise products sold under a common brand and the circumstances may help the user to select a product. In this example, the device 100 would present topics, each having a plurality of products and the output is one of the plurality of products as a function of the defined circumstances input by the user of the device.

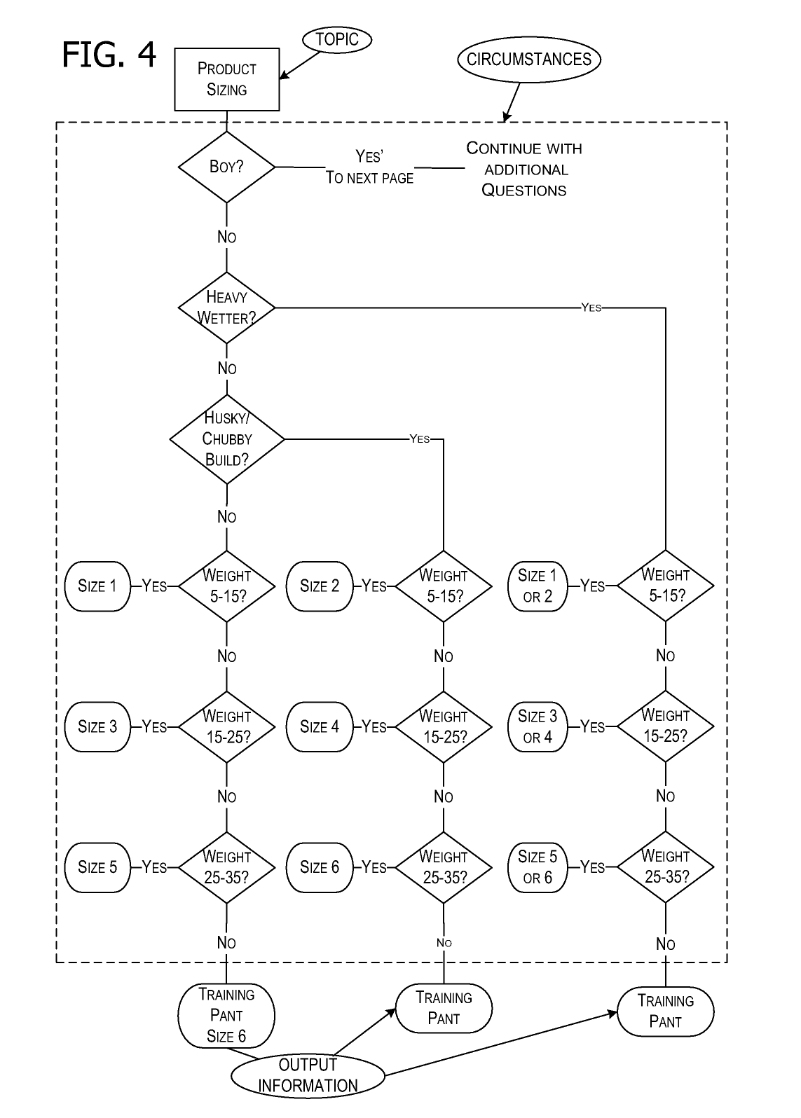

As a particular example, the topic may be the size of a product such as training pants. FIG. 4 illustrates a partial flow chart of instructions for determining a product size, i.e., the topic. Questions (i.e., circumstances) relating to the sex, build, wetting history and weight of the product recipient may be asked of a user of device 100 via display 112. Answers provided by the user via input device 110 direct further questioning and determine the recommended size of training pants, i.e., the output information.

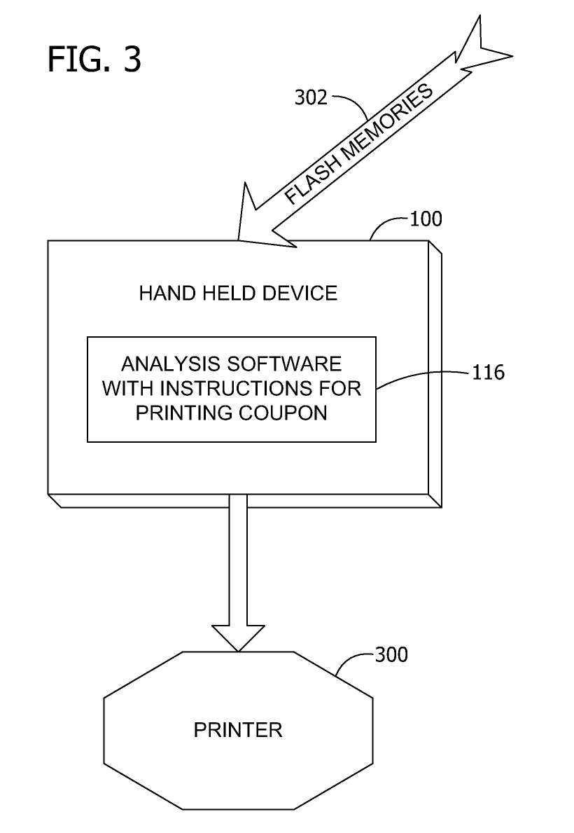

In one embodiment, the device 100 as illustrated in FIG. 3 may include analysis software 116 which also includes instructions for driving a printer 300 for printing a coupon relating to the output information. For example, if the topic is determining a product size and the output is a specific product, the device 100 may interface with a printer (via a wireless connection such as Bluetooth or via a hard-wired connection) to print a coupon identifying the specific product.

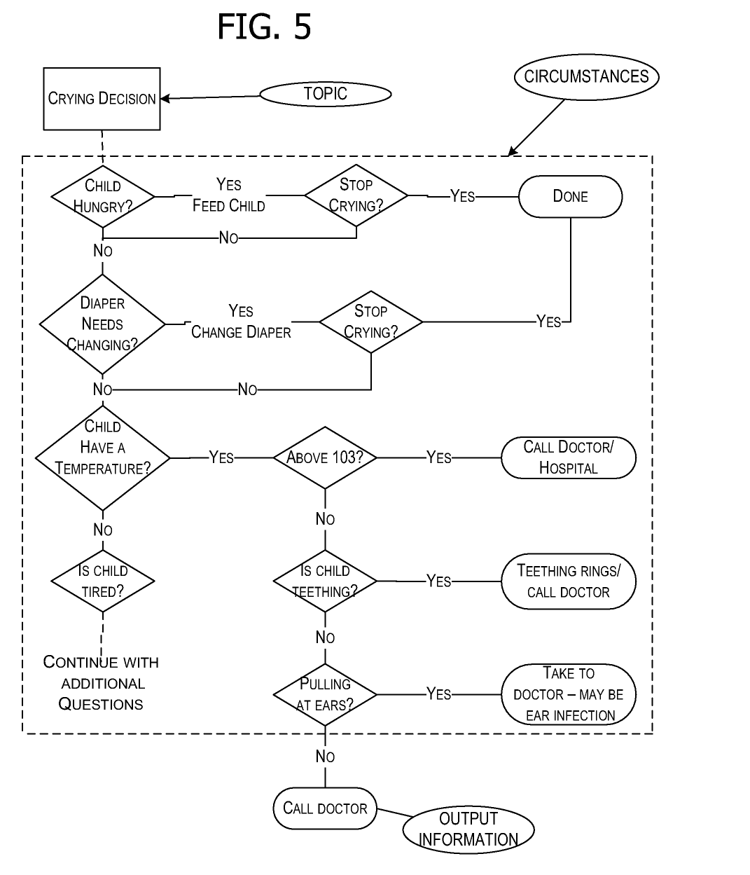

As another example, the topic may be medical or health issues such as making a decision as to how to treat a crying child. FIG. 5 illustrates a flow chart of instructions for determining an action in response to crying, i.e., the topic. Questions (i.e., circumstances) relating to the hunger, diaper needs, body temperature, energy level, teething condition, and ear condition of the crying child may be asked of a user of device 100 via display 112. Answers provided by the user via input device 110 direct further questioning and determine the recommended course of action, i.e., the output information.

In one embodiment as illustrated in FIG. 1, one or more optional radio frequency identification (RFID) devices 130 may be used in combination with the device 100. Each RFID device 130 would be placed a different location and would trigger device 100 to identify a specific topic. The RFID devices may be active or passive and the device 100 would include an optional RFID reader 132 to communicate with the RFID devices 130. As the device 100 is moved close enough to read a particular RFID device 130, the RFID device 130 would identify a topic. For example, the topic may be one of a plurality of products along an isle and the output may be a recommendation of a particular one of the plurality of products as a function of the defined circumstances. Specifically, one of the RFID devices 130 could be located in a diaper aisle that a consumer may traverse. The device 100 would include a series of questions to elicit circumstances from the consumer to help the consumer identify which diaper to purchase.

Thus, in one embodiment, the device 100 further comprises RFID devices 130 for indicating the topic. The RFID reader 132 communicates with the RFID devices 130 for determining the indicated topic. The reader 132 provides the indicated topic to the processor 108. In one example, the topic is a plurality of products and the output information is a recommendation of a particular one of the plurality of products as a function of the defined circumstances.

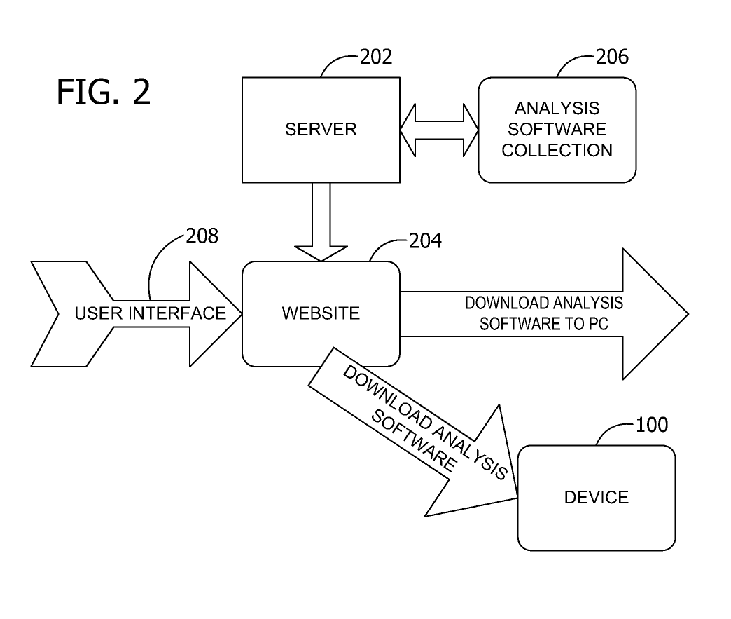

Referring to FIG. 2, one optional embodiment of the device 100 includes the capability to download the analysis software 116 into its memory 114. For example, the device 100 may have a wired or wireless interface which connects to a computer such as a personal computer or a server 202 via a website 204. The server would have access to a collection 206 of analysis software including one or more sets of analysis instructions relating to various topics. A user, via a user interface 208, would select one of the plurality of analysis instruction sets from the collection 206 and download the selected set of instructions into the memory 114 of the device 100. For example, a user of device 100 may be going on a sightseeing trip to a particular destination and the user would download analysis software into the device which would assist the user determining which sights to see at the particular destination.

In another embodiment, the analysis software 116 comprises a plurality of analysis instruction sets and one of the plurality of analysis instruction sets is selected by the user for execution.

In one embodiment, as illustrated in FIG. 2, the invention comprises an expert advice website 204. The server 202 presents at least one webpage 204 accessible via the Internet wherein the webpage includes the user interface 208. The server 202 receives user input from the user interface 208 and drives the webpage 204 in responsive to the received user input. The analysis software 206 is stored in a memory accessible by the server 202 and executed by the server. In this embodiment, a user would access the webpage 204 and answer questions presented by the webpage in order to determine a topic, identify circumstances and be provided with output information relating thereto.

Optionally, the analysis software sets 206 may be downloadable to a personal computing device for execution by the personal computing device (PC) or downloaded to the PC for further downloading to the device 100.

In yet another optional embodiment as illustrated in FIG. 3, the device 100 interfaces with memory cards or a plurality of flash memories 302. Each memory 302 has analysis software relating to a different topic and one of the flash memories is connected to the processor 108 for executing the analysis software of the connected flash memory.

In one embodiment, the analysis software includes a decision matrix algorithm capable of providing a solution to an individual's question about a specific topic. The logic behind the device is similar to that of the “20 questions” game, in which a first individual thinks of an object (predetermined) and a second individual asks specific questions (yes/no/sometimes/unknown) to narrow down a probable guess. The analysis software differs in that the first individual does not have a pre-determined solution in mind, rather a general topic area. An individual uses the device 100 to come up with information, (e.g., a solution). For example, a caregiver may know their child is not feeling well, but not know why. By asking a series of deductive questions, the probable root-cause can be narrowed or determined. This would be similar to the types of questions a phone service uses. One advantage of the device 100 is that the individual can have the device 100 at home, use it any time, and not have to wait on the phone for help to determine a root cause.

In one embodiment, it is contemplated that the analysis software 116 may be incorporated into a portable device such as a cell phone and/or a PDA (personal digital assistant).

### EXAMPLES

The following non-limiting examples are provided to further illustrate the present invention.

In one form, the device provides expert guidance to help build brand identity and to associate the brand as expert in a specific area, e.g. a children's products supplier providing a decision tree for toilet training suggestions, newborn health, parenting suggestions, advice for terrible 2's.

In the context of medical and/or health issues, the device with be a medical type database which a parent can use to answer questions related to health, e.g., by asking specific questions (e.g. fever? runny nose?, etc) the device can recommend next steps.

When using the device 100 with RFID devices 130, the RFID devices cue questions automatically depending on the location or condition of the device 100 relative to the RFID devices 130. The device 100 may help with shopping in a store where RFID tags in an isle trigger questions to help guide consumers as to which product to buy; e.g., do you need milk?, what size?, what kind? The device can also assist in product selection and identify the best product form based on user answers to a series of questions (e.g., absorbency needs, fit, and comfort regarding diapers) and/or to identify a product tier.

The device may assist in consumer brand marketing. Based on needs assessed from questions, the device would recommend a brand to purchase (e.g., nose is running; buy KLEENEX®) and the device could also contain a driver to print coupons based on solution provided.

The device may be in the form of a base system with download option. The system either accepts flash memory types or other means of downloading specific decision trees based on the changing needs of consumer, such as:
a separate card for each child's age (newborn, toddler, and teen suggestions).
cards for cooking, wine selection, automotive information, basic home repair/problems.
homework help; math, science.

One advantage of the device 100 is that differs from the prior art in which the user knew the answer and logic was used to find the user's answer. In the device 100, the user may not know the right answer/question to ask. By having a decision tree algorithm which asks questions, a root cause can be determined by the user. Additionally, device 100 provides a means of editing decision tree algorithms depending on end user category needs (e.g., caregiving versus wine selection) via either a download or other data transfer systems (e.g., flash cards) or RFID association. In addition, the prior art does not recognize the use of such systems and methods to advertise a brand via the solution, course of action and/or definition (e.g., to build brands/recommend brand products to purchase).

Having described the invention in detail, it will be apparent that modifications and variations are possible without departing from the scope of the invention defined in the appended claims.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A device comprising:
A display;
A user input device;
A processor connected to the user input device for receiving user input and connected to the display for driving the display in responsive to the received user input;
A storage; and
Analysis software stored in the storage and executed by the processor, said analysis software including:
Instructions for displaying questions on the display and receiving user input to identify a topic;
Instructions for displaying questions on the display and receiving user input to define circumstances within the identified topic; and
Instructions for presenting on the display output information relating to the identified topic as a function of the defined circumstances wherein the output information comprises at least one of a solution, a course of action or a definition of a problem.

2. The device of claim 1 wherein the topic comprises at least one of products sold under a common brand, medical issues and health issues.

3. The device of claim 1 wherein the topic comprises a plurality of products sold and wherein the output information is one of the plurality of products as a function of the defined circumstances.

4. The device of claim 1 further comprising an RFID device for indicating the topic and an RFID reader communicating with the RFID device for determining the indicated topic and providing the indicated topic to the processor.

5. The device of claim 4 wherein the topic is a plurality of products and wherein the output information is a recommendation of a particular one of the plurality of products as a function of the defined circumstances.

6. The device of claim 1 wherein the analysis software comprises instructions for driving a printer for printing a coupon relating to the output information.

7. The device of claim 1 wherein the storage comprises a plurality of flash memories, each having said analysis software relating to a different topic and wherein one of the flash memories is connected to the processor, said processor executing the analysis software of the connected flash memory.

8. The device of claim 1 wherein the analysis software is downloaded into the storage.

9. The device of claim 1 wherein the analysis software comprises a plurality of analysis instruction sets and wherein one of the plurality of analysis instruction sets is downloaded into the storage.

10. An expert advice website comprising:
A user interface;
A server for presenting at least one webpage accessible via the Internet wherein the webpage includes the user interface, said server receiving user input from the user interface and driving the webpage in responsive to the received user input;
A storage; and
Analysis software stored in the storage and executed by the server, said analysis software including:
Instructions for displaying questions on the webpage via the user interface and receiving user input to identify a topic;
Instructions for displaying questions on the webpage via the user interface and receiving user input to define circumstances within the identified topic; and
Instructions for presenting on the webpage via the user interface an output information relating to the identified topic as a function of the defined circumstances wherein the output information comprises at least one of a solution, a course of action or a definition of a problem.

11. The website of claim 10 wherein the analysis software is downloadable to at least one of the following: a personal computing device for execution by the personal computing device; a cell phone for execution by the cell phone; and a PDA (personal digital assistant) for execution by the PDA.

12. The website of claim 10 wherein the topic comprises at least one of products sold under a common brand, medical issues and health issues.

13. The website of claim 10 wherein the topic comprises a plurality of products sold and wherein the output information is one of the plurality of products as a function of the defined circumstances.

14. The website of claim 14 wherein the topic is a plurality of products and wherein the output information is a recommendation of a particular one of the plurality of products as a function of the defined circumstances.

15. The website of claim 10 wherein the analysis software comprises instructions for printing a coupon relating to the output information.

16. The website of claim 10 wherein the analysis software comprises a plurality of analysis instruction sets and wherein one of the plurality of analysis instruction sets is selected by the user.

17. An expert advice website comprising:
A user interface;
A server for presenting at least one webpage accessible via the Internet wherein the webpage includes the user interface, said server receiving user input from the user interface and driving the webpage in responsive to the received user input;
A storage; and
Analysis software stored in the storage and downloadable from the storage via the server to a remote device,
said analysis software stored in a memory of the remote device and executed by a processor of the remote device, said analysis software including:
Instructions for displaying questions on a display of the remote device and receiving user input to identify a topic;
Instructions for displaying questions on the display of the remote device and receiving user input to define circumstances within the identified topic; and
Instructions for presenting on the display of the remote device an output information relating to the identified topic as a function of the defined circumstances wherein the output information comprises at least one of a solution, a course of action or a definition of a problem.

18. The website of claim 17 wherein the remote device comprises at least one of the following: a personal computing device for executing the downloaded analysis software; a cell phone for executing the downloaded analysis software; and a PDA (personal digital assistant) for executing the downloaded analysis software.

19. The website of claim 17 wherein the topic comprises at least one of products sold under a common brand, medical issues and health issues.

20. The website of claim 17 wherein the topic comprises a plurality of products sold and wherein the output information is one of the plurality of products as a function of the defined circumstances.

21. The website of claim 20 wherein the topic is a plurality of products and wherein the output information is a recommendation of a particular one of the plurality of products as a function of the defined circumstances.

22. The website of claim 17 wherein the analysis software comprises instructions for printing a coupon relating to the output information.

23. The website of claim 17 wherein the analysis software comprises a plurality of analysis instruction sets and wherein one of the plurality of analysis instruction sets is selected by the user for downloading into the remote device.
